(19) United States
(12) Patent Application Publication
(10) Pub. No.: US 2008/0024662 A1
(43) Pub. Date: Jan. 31, 2008

(54) DISPLAY WITH BUILT-IN VIDEO PROCESSOR

(76) Inventor: James Chu, Walnut, CA (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/460,282

(22) Filed: Jul. 27, 2006

(51) Int. Cl. H04N 7/00; H04N 5/44

(52) U.S. Cl. 348/553; 348/552; 715/718

(57) ABSTRACT

A display with built-in video processor includes a display being internally provided with a female connector for transferring received signals to the built-in video processor, which demodulates the received digital audio/video signals and displays the signals on a panel of the display; and an external signal receiver for receiving and demodulating wireless digital audio/video signals. The external signal receiver has a male connector for connecting to the female connector in the display, so as to demodulate and transmit the received wireless digital audio/video signals to the video processor via the female connector for processing and displaying on the panel. The external signal receiver has a uniform specification for use with computer displays, LCD-TVs, plasma TVs, or digital projectors having matching specification to receive wireless signals.

### FIELD OF THE INVENTION

The present invention relates to a display, and more particularly to a display with built-in video processor.

### BACKGROUND OF THE INVENTION

It is generally known that a television (TV) set is required for watching TV programs. The TV set has an internal image receiving unit to receive and convert the received external audio/video (A/V) signals. In the future, almost all the TV programs and TV broadcasting A/V signals would be transmitted wirelessly. Meanwhile, with the advancements in scientific technologies, most people have a computer used at home on a long-term basis. Therefore, the display of the computer may be utilized as a TV to watch TV programs and save the space originally occupied by the conventional TV set. FIG. 1 shows a conventional way of using a computer display to watch TV programs. As shown, a TV card 10 is installed in a computer host 12, so that the computer host 12 may receive TV signals via the TV card 10. The received video signals are demodulated and converted by the central processing unit of the computer, and then transmitted to and played on a display 14 of the computer. Therefore, a user may watch TV programs on the computer display 14.

A disadvantage of the above-described conventional way of watching TV programs on a computer display is that the computer must be always turned on for receiving the video signals via the TV card 10. It is of course not economical to turn on the computer all the time. Another conventional way of watching TV programs on a computer display is to externally connect a set-top box (not shown) to the computer display. The set-top box receives external wireless A/V signals, and the received signals are demodulated and converted at the set-top box and then transmitted to the computer display for playing. The set-top box must be connected to an external power supply and could not be combined with the computer display. That is, the set-top box would still occupy an independent space without the benefit of saving the valuable space.

It is therefore tried by the inventor to develop a display with built-in video processor to solve the problems in watching TV programs on a computer display using conventional ways.

### SUMMARY OF THE INVENTION

A primary object of the present invention is to provide a display with built-in video processor for playing images of digital signals received and demodulated by an external signal receiver without the need of using a conventional set-top box that is externally connected to the display to occupy an additional space.

Another object of the present invention is to provide a display with built-in video processor for playing images of digital signals received and demodulated by an external signal receiver without the need of using a conventional TV card in a computer to operate and convert signals, so as to effectively save power energy.

A further object of the present invention is to provide a display with built-in video processor that has an external signal receiver of a uniform specification to be used with computer displays; liquid crystal display television sets (LCD-TVs); plasma TVs; and digital projectors of matching specification to receive wireless signals.

To achieve the above and other objects, the display with built-in video processor according to the present invention includes a display being internally provided with a female connector for transferring received signals to the built-in video processor, which demodulates the received digital audio/video signals and displays the demodulated signals on a panel of the display; and an external signal receiver for receiving and demodulating wireless digital audio/video signals. The external signal receiver has a male connector for connecting to the female connector of the display, so as to demodulate and transmit the received wireless digital audio/video signals to the video processor via the female connector for processing and displaying on the panel. The external signal receiver has a uniform specification for use with computer displays, LCD-TVS, plasma TVs, or digital projector having matching specification to receive wireless signals.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional way of watching TV programs on a computer display;

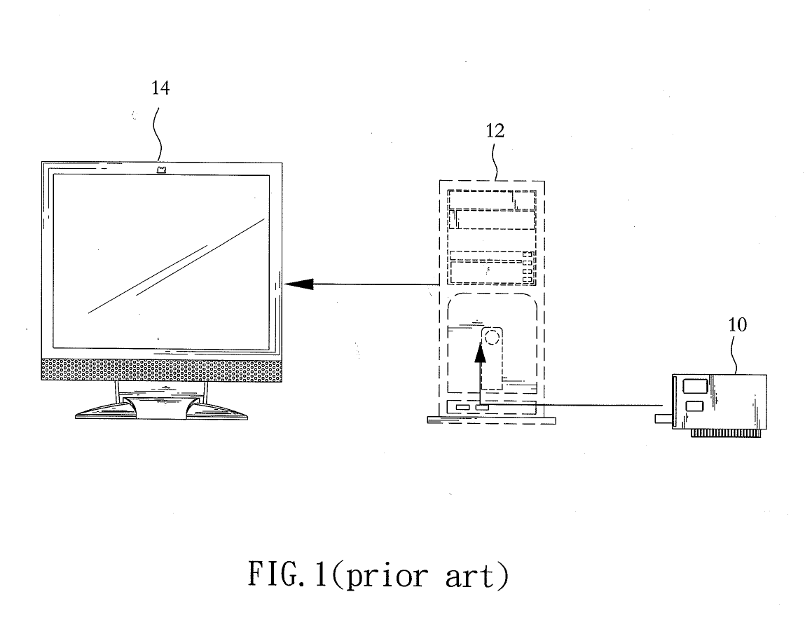

FIG. 2 is a front view of a display with built-in video processor according to an embodiment of the present invention; and

FIG. 3 is a rear view of the display with built-in video processor shown in FIG. 2.

### DETAILED DESCRIPTION OF THE PREFERRED EMBODIMENTS

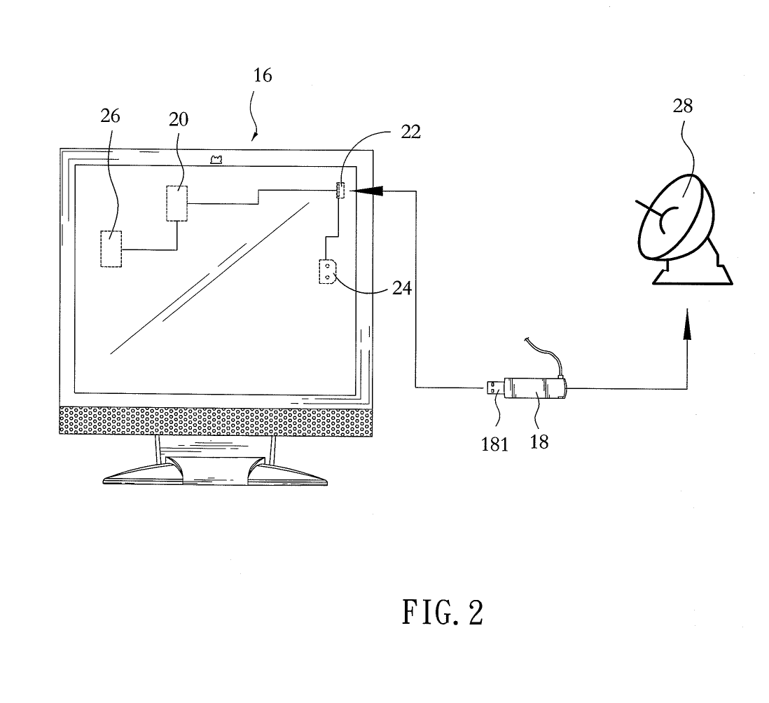

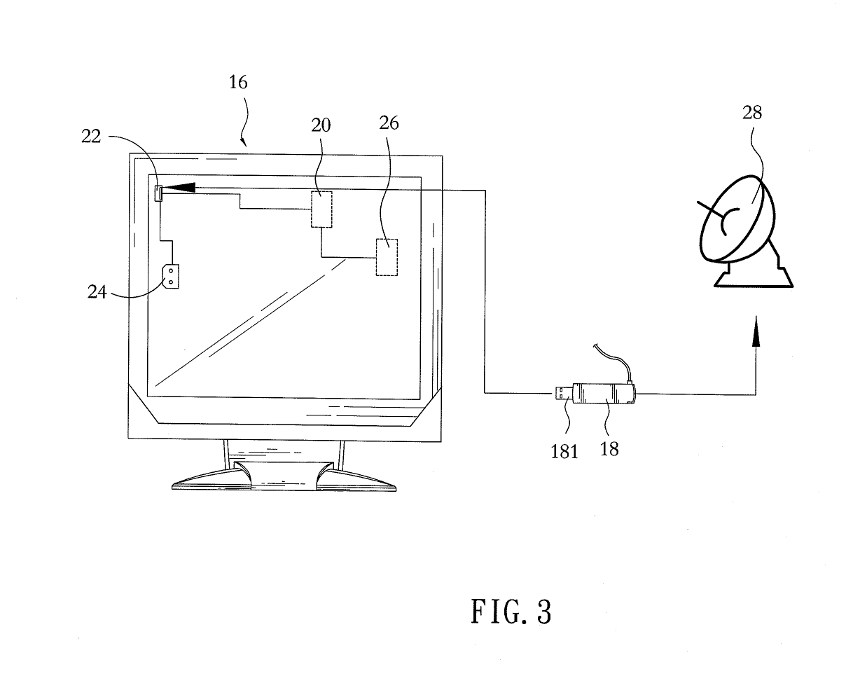

Please refer to FIGS. 2 and 3 that are front and rear views, respectively, of a display with built-in video processor according to an embodiment of the present invention. As shown, the present invention includes two major parts, namely, a display 16 and an external signal receiver 18. The display 16 has a built-in video processor 20 for playing images on a panel of the display 16, and is internally provided with a female connector 22 for connecting to the video processor 20 and a power supply 24, which is also provided in the display 16, and an erasable and programmable read-only memory (EPROM) that is connected to the video processor 20 and has a firmware program stored thereon for image conversion. The power supply 24 supplies power to the external signal receiver 18. The external signal receiver 18 is connected at a male connector 181 to the female connector 22, so that wireless signals, including video and audio signals, received and demodulated by the external signal receiver 18 are transmitted to the video processor 20 via the female connector 22 for playing. At this point, video processor 20 would run the image conversion firmware program stored on the memory 26, so as to directly play images on the panel of the display 16. The wireless signals emitted from a emission base station 28 and received by the external signal receiver 18 may be DVB-T (Digital Video Broadcasting-Terrestrial) signals, DVB-S (Digital Video Broadcasting-Satellite) signals, or ATSC (Advanced Television Systems Committee) digital broadcasting signals. And, in the present invention, the male connector 181 and the female connector 22 are of a USB 2.0 high-speed serial connection interface or a 1394 high-speed serial connection interface.

As having been mentioned above, in the past, when it is desired to watch TV programs on a computer display, the computer must be always turned on for receiving the video signals via a TV card, and would therefore disadvantageously consume a lot of power. And, when a set-top box is utilized to watch TV programs on a computer display, the set-top box must be connected to an external power supply and could not be combined with the computer display, and would therefore occupy an independent space without the benefit of saving the valuable space. However, the display with built-in video processor of the present invention is applicable to general computer displays, LCD-TVs (liquid crystal display televisions), plasma TVs, and digital projectors, and the external signal receiver has a uniform specification and may be used with any computer displays, LCD-TVs, plasma TVs, and digital projectors having a matching specification. With the built-in video processor 20 and the external signal receiver 18, the display 16 of the present invention allows a consumer to watch A/V programs thereon. The display 16 of the present invention does not occupy extra space and meets the new trends of displays.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A display with built-in video processor, comprising:
a display internally provided with a female connector for connecting signals to a video processor built in said display; said built-in video processor being capable of displaying the signals on a panel of said display; and
an external signal receiver for receiving and demodulating wireless digital video and audio signals, said external signal receiver having a male connector for connecting to said female connector in said display, so as to demodulate and transmit the received wireless digital video and audio signals to said built-in video processor via said female connector for processing.

2. The display with built-in video processor as claimed in claim 1, wherein said external signal receiver is capable of receiving and demodulating either wireless digital audio/video signals or wireless analog audio/video signals.

3. The display with built-in video processor as claimed in claim 1, wherein said display supplies power to said external signal receiver via connection of said female connector of said display to said male connector of said external signal receiver.

4. The display with built-in video processor as claimed in claim 1, wherein said display is selected from the group consisting of computer displays, LCD television sets, plasma television sets, and digital projectors.

5. The display with built-in video processor as claimed in claim 1, wherein said external signal receiver has a uniform specification for use with computer displays, LCD television sets, plasma television sets, or digital projectors having a specification matching that of said external signal receiver.

6. The display with built-in video processor as claimed in claim 1, wherein said male connector of said external signal receiver and said female connector in said display are of a USB 2.0 high-speed serial connection interface.

7. The display with built-in video processor as claimed in claim 1, wherein said male connector of said external signal receiver and said female connector in said display are of a 1394 high-speed serial connection interface.

8. The display with built-in video processor as claimed in claim 1, further comprising an erasable programmable read-only memory (EPROM) having an image conversion firmware program stored thereon.

9. The display with built-in video processor as claimed in claim 8, wherein said wireless signals received by said external signal receiver are transmitted to said built-in video processor of said display, and said video processor runs said image conversion firmware program stored on said EPROM to demodulate the received signals, so that images are directly displayed on a panel of the display.

10. The display with built-in video processor as claimed in claim 1, wherein said wireless signal is of a DVB-T signal.

11. The display with built-in video processor as claimed in claim 1, wherein said wireless signal is of an ATSC digital broadcasting signal.
